(19) United States
(12) Patent Application Publication
(10) Pub. No.: US 2018/0224296 A1
(43) Pub. Date: Aug. 9, 2018

(54) IMAGE PROCESSING SYSTEM AND IMAGE PROCESSING METHOD

(71) Applicants: TOYOTA JIDOSHA KABUSHIKI KAISHA, Toyota-shi (JP); AISIN AW CO., LTD., Anjo-shi (JP)

(72) Inventors: Koichi SUZUKI, Miyoshi-shi (JP); Junichiro IGAWA, Okazaki-shi (JP)

(73) Assignees: TOYOTA JIDOSHA KABUSHIKI KAISHA, Toyota-shi (JP); AISIN AW CO., LTD., Anjo-shi (JP)

(21) Appl. No.: 15/891,001

(22) Filed: Feb. 7, 2018

(30) Foreign Application Priority Data
Feb. 9, 2017 (JP) 2017-022365

(51) Int. Cl. G01C 21/36; G01C 21/34; G01C 21/30; G06K 9/00

(52) U.S. Cl. CPC G01C 21/3602; G01C 21/3492; G06K 9/00798; G06K 9/00818; G01C 21/30

(57) ABSTRACT

An image processing system includes: an imaging device mounted in a vehicle and an information processing device. The vehicle includes an image acquiring unit configured to acquire a plurality of images captured by the imaging device. The information processing device includes a first reception unit configured to receive a first image from the image acquiring unit, a first detection unit configured to detect, based on the first image, predetermined information including at least one of marker information of a marker indicating a crossroads and congestion information on congestion, a second reception unit configured to receive a second image from the image acquiring unit when the predetermined information is not detected by the first detection unit, and a second detection unit configured to detect the predetermined information based on the first image and the second image or based on the second image.

### INCORPORATION BY REFERENCE

The disclosure of Japanese Patent Application No. 2017-022365 filed on Feb. 9, 2017 including the specification, drawings and abstract is incorporated herein by reference in its entirety.

### BACKGROUND

### 1. Technical Field

The disclosure relates to an image processing system and an image processing method.

### 2. Description of Related Art

In the related art, a technique of detecting a cause of congestion or the like based on an image acquired by imaging the surroundings of a vehicle is known.

For example, a system may first collect images acquired by imaging the surroundings of each vehicle for determination of a cause of congestion. Then, the system may detect a vehicle at the head of the congestion based on the collected images. Then, the system may determine a cause of the congestion based on images obtained by imaging a head position at which the vehicle at the head of the congestion is located in multiple directions. In this way, a technique of causing a system to detect traffic congestion and determine a cause of the traffic congestion is known (for example, see Japanese Unexamined Patent Application Publication No. 2008-65529 (JP 2008-65529 A)).

### SUMMARY

However, in the related art, a large amount of images are often transmitted and received between a vehicle and an information processing device. Accordingly, an amount of data for transmitting and receiving images is large and a problem with a pressure on communication lines is likely to occur.

Therefore, an image processing system according to an embodiment of the disclosure determines whether to add an image which is used for detection in detecting predetermined information. As a result, the disclosure provides an image processing system and an image processing method that can reduce an amount of data for transmitting and receiving images.

A first aspect of the disclosure provides an image processing system. The image processing system includes: an imaging device mounted in a vehicle and an information processing device. The vehicle includes an image acquiring unit configured to acquire a plurality of images indicating surroundings of the vehicle. The plurality of images are captured by the imaging device. The information processing device includes: a first reception unit configured to receive a first image among the plurality of images from the image acquiring unit; a first detection unit configured to detect, based on the first image, predetermined information including at least one of marker information of a marker indicating a crossroads and congestion information on congestion occurring around a position at which the first image is captured; a second reception unit configured to receive a second image among the plurality of images from the image acquiring unit when the predetermined information is not detected by the first detection unit; and a second detection unit configured to detect the predetermined information based on the first image and the second image or based on the second image.

First, the image processing system captures a plurality of images indicating the surroundings of a vehicle using the imaging device. The first image and the second image are acquired by the image acquiring unit. Then, the information processing device receives the first image from the vehicle side and detects the predetermined information therein. Subsequently, when the predetermined information cannot be detected in only the first image, the information processing device additionally receives the second image. Accordingly, when the predetermined information is detected in only the first image, it is not necessary to transmit and receive the second image. Therefore, when it is determined that the second image is not necessary, the second image is not transmitted and received and thus an amount of data which is transmitted and received between the vehicle and the information processing device in the image processing system is frequently lower. As a result, the image processing system can reduce an amount of data for transmitting and receiving images.

In the first aspect, the marker may include at least one of a signboard, a building, a painted part, a lane, and a feature or a sign of a road which are installed in a vicinity of the crossroads.

In the first aspect, the imaging device may be configured to capture the plurality of images when a position of the vehicle is within a predetermined distance from the crossroads.

In the first aspect, the first image may be an image which is captured when the vehicle is located at a position closer to the crossroads than a position at which the second image is captured.

In the first aspect, the image processing system may include: a map data acquiring unit configured to acquire map data indicating a current position of the vehicle, a destination, and intermediate routes from the current position to the destination; and a guidance unit configured to perform guidance for a route in which the vehicle travels based on the map data. The guidance unit may be configured to perform guidance for the crossroads using the marker based on the predetermined information.

In the first aspect, the congestion information may include a position at which the vehicle joins congestion, a cause of the congestion, or a distance of the congestion.

A second aspect of the disclosure provides an image processing method. The image processing image includes: acquiring a plurality of images indicating surroundings of a vehicle, the plurality of the images being captured by an imaging device mounted in the vehicle; receiving a first image of the plurality of images using at least one information processing device; detecting predetermined information in the first image using the at least one information processing device, the predetermined information including at least one of marker information of a marker indicating a crossroads and congestion information on congestion occurring around the vehicle; receiving a second image of the plurality of images using the at least one information processing device when the predetermined information is not detected in the first image using the at least one information processing device; and detecting the predetermined information based on the first image and the second image or based on the second image using the at least one information processing device.

In the second aspect, the image processing method may include storing the predetermined information in a database which is accessible by an on-board device mounted in the vehicle.

A third aspect of the disclosure provides an image processing system. The image processing system includes: at least one server configured to communicate with a vehicle. The at least one server includes a storage device and a processing device. The processing device is configured to: receive a first image among a plurality of images acquired by an imaging device mounted in the vehicle, the plurality of images indicating surroundings of the vehicle; detect predetermined information in the first image, the predetermined information including at least one of marker information of a marker indicating a crossroads and congestion information on congestion occurring around a position at which the first image is captured; request the vehicle to transmit a second image acquired at a position other than the position at which the first image is acquired when the predetermined information is not detected in the first image; and receive the second image and detect the predetermined information in the second image.

In the third aspect, the at least one server may be configured to transmit at least one of the marker information and information on a position of congestion prepared using the congestion information to at least one of the vehicle and a vehicle other than the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of an entire configuration and a hardware configuration of an image processing system according to an embodiment of the disclosure;

FIG. 2 is a diagram illustrating an example in which the image processing system according to the embodiment of the disclosure is used;

FIG. 3A is a flowchart illustrating an example of operations which are performed by a camera and an image acquiring device in a first overall processing routine which is performed by the image processing system according to the embodiment of the disclosure;

FIG. 3B is a flowchart illustrating an example of operations which are performed by a server in the first overall processing routine which is performed by the image processing system according to the embodiment of the disclosure;

FIG. 4 is a (first) diagram illustrating an example of advantages of the first overall processing routine according to the embodiment of the disclosure;

FIG. 5 is a (second) diagram illustrating an example of advantages of the first overall processing routine according to the embodiment of the disclosure;

FIG. 6 is a flowchart illustrating an example of a processing routine of performing acquisition of map data and guidance in the image processing system according to the embodiment of the disclosure;

FIG. 7A is a flowchart illustrating an example of operations which are performed by a camera and an image acquiring device in a second overall processing routine which is performed by the image processing system according to the embodiment of the disclosure;

FIG. 7B is a flowchart illustrating an example of operations which are performed by a server in the second overall processing routine which is performed by the image processing system according to the embodiment of the disclosure;

FIG. 8 is a (first) diagram illustrating an example of advantages of the second overall processing routine according to the embodiment of the disclosure; and

FIG. 9 is a functional block diagram illustrating an example of a functional configuration of the image processing system according to the embodiment of the disclosure.

### DETAILED DESCRIPTION OF EMBODIMENTS

Hereinafter, an embodiment of the disclosure will be described with reference to the accompanying drawings.

<Example of Entire Configuration and Hardware Configuration>

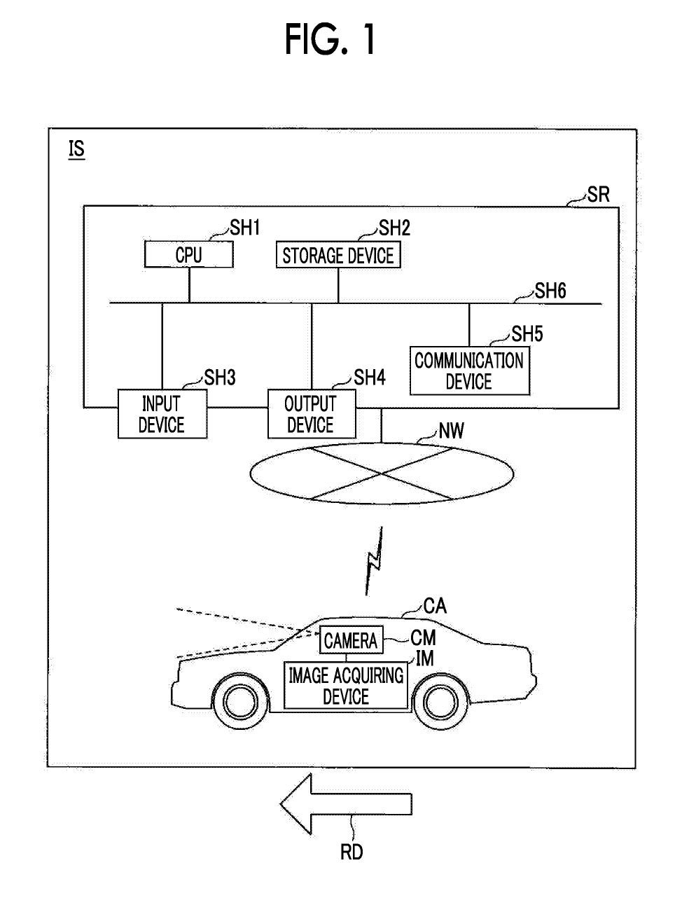

FIG. 1 is a diagram illustrating an example of an entire configuration and a hardware configuration of an image processing system according to an embodiment of the disclosure. In the illustrated example, an image processing system IS includes a camera CM which is an example of an imaging device and a server SR which is an example of an information processing device.

As illustrated in the drawing, the camera CM which is an example of an imaging device is mounted in a vehicle CA. The camera CM images the surroundings of the vehicle CA and generates an image. For example, as illustrated in the drawing, the camera CM may image an area in front of the vehicle CA. The image generated by the camera CM is acquired by an image acquiring device IM.

The image acquiring device IM includes a processor and a controller such as an electronic circuit, an electronic control unit (ECU), and a central processing unit (CPU). The image acquiring device IM further includes an auxiliary storage unit such as a hard disk, and stores the image acquired from the camera CM. The image acquiring device IM includes a communication unit such as an antenna and a processing integrated circuit (IC), and transmits the image to an external device such as the server SR via a network NW.

A plurality of cameras CM and a plurality of image acquiring devices IM may be provided. A plurality of vehicles CA may be provided.

On the other hand, the server SR is connected to the vehicle CA via a network or the like. The server SR includes, for example, a CPU SH1, a storage device SH2, an input device SH3, an output device SH4, and a communication device SH5.

The hardware resources of the server SR are connected to each other via a bus SH6. The hardware resources transmit and receive signals and data via the bus SH6.

The CPU SH1 serves as a processor and a controller. The storage device SH2 is a main storage device such as a memory. The storage device SH2 may further include an auxiliary storage device. The input device SH3 is a keyboard or the like and receives an operation from a user. The output device SH4 is a display or the like and outputs a processing result and the like to a user. The communication device SH5 is a connector, an antenna, or the like and transmits and receives data to and from an external device via a network NW, a cable, or the like.

The server SR is not limited to the illustrated configuration and, for example may further include devices. A plurality of servers SR may be provided.

<Example of Use>

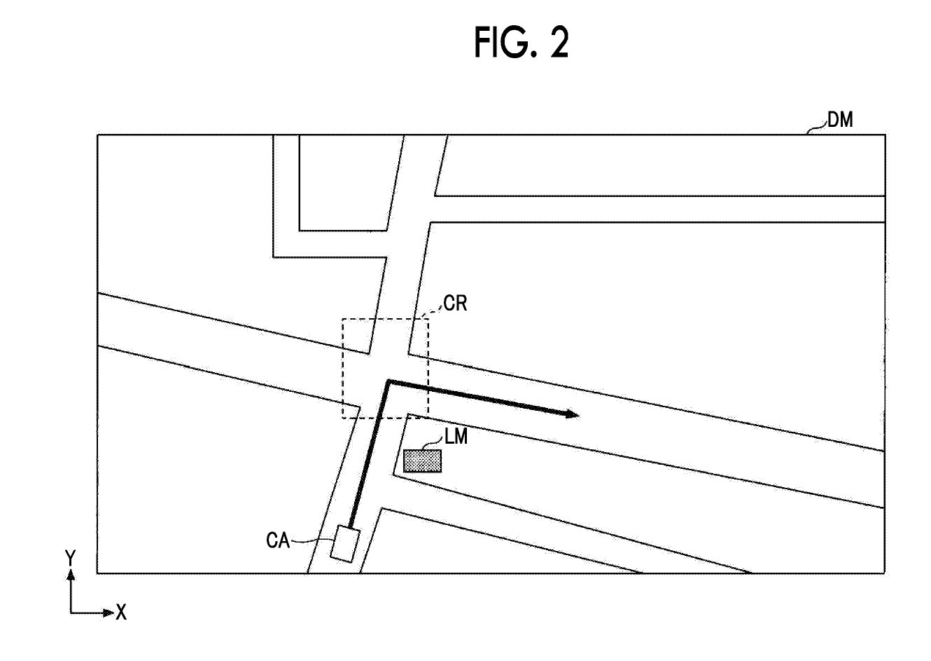

FIG. 2 is a diagram illustrating an example in which the image processing system according to the embodiment of the disclosure is used. Hereinafter, a situation illustrated in the drawing will be described as an example.

For example, as illustrated in the drawing, it is assumed that the vehicle CA travels to a destination. In a route to the destination, as illustrated in the drawing, the vehicle CA travels in a route which turns to the right at a crossroads CR in front thereof (a route indicated by an arrow in the drawing). That is, in this situation, when a so-called car navigation device is mounted in the vehicle CA, the car navigation device performs guidance of a driver who drives the vehicle CA by a voice, an image, or a combination thereof such that the vehicle turns to the right at the crossroads CR.

For example, when map data DM is received from an external device or map data DM is acquired using a recording medium, the vehicle CA can see the position of the host vehicle, the position of the crossroads CR, that the destination is located on a right side from the crossroads CR, and the like.

Hereinafter, the illustrated example will be described, but the image processing system is not limited to the illustrated example and may be used, for example, at a point other than a crossroads.

<Example of First Overall Processing Routine>

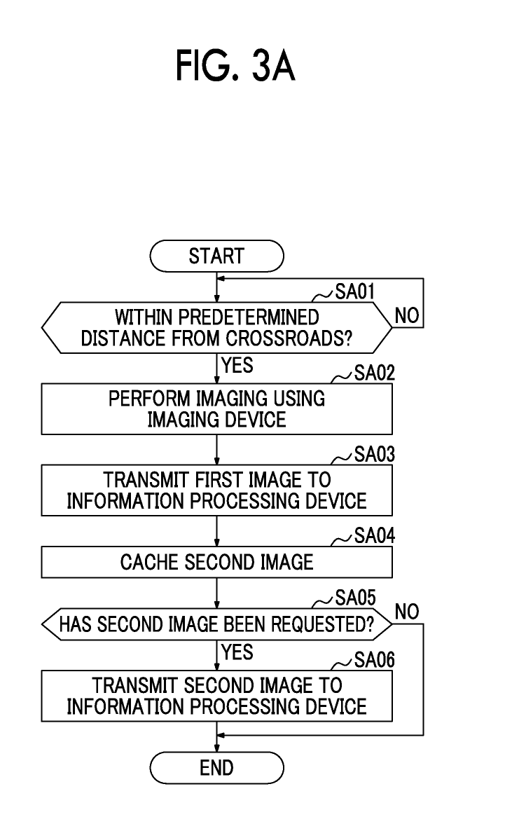

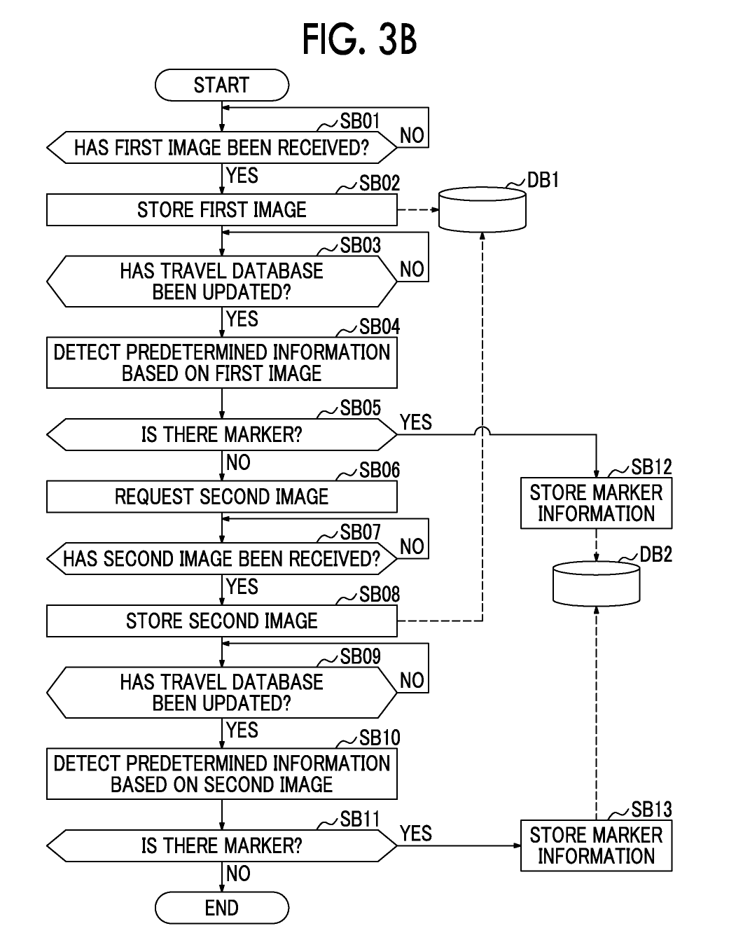

FIGS. 3A and 3B are flowcharts illustrating an example of a first overall processing routine which is performed by the image processing system according to the embodiment of the disclosure. In the first overall processing routine illustrated in the drawing, the processing routine illustrated in FIG. 3A is an example of a process which is performed by the camera CM (see FIG. 1) or the image acquiring device IM (see FIG. 1) which is mounted in the vehicle CA. On the other hand, in the first overall processing routine illustrated in the drawings, the processing routine illustrated in FIG. 3B is an example of a process which is performed by the server SR (see FIG. 1).

In Step SA01, the image processing system determines whether the vehicle CA is located at a position within a predetermined distance from the crossroads CR (see FIG. 2). It is assumed that the predetermined distance can be set in advance by a user or the like. That is, the image processing system determines whether the vehicle CA approaches the crossroads CR.

Then, when the image processing system determines that the vehicle is located at a position within the predetermined distance (YES in Step SA01), the image processing system performs Step SA02. On the other hand, when the image processing system determines that the vehicle is not located at a position within the predetermined distance (NO in Step SA01), the image processing system performs Step SA01 again.

In Step SA02, the image processing system captures an image using the imaging device. That is, the image processing system starts capturing of an image using the imaging device and captures a plurality of images indicating an area in front of the vehicle CA until the vehicle CA reaches the crossroads CR. Hereinafter, all the images captured in Step SA02 are referred to as “all images.”

Specifically, it may be assumed that the vehicle CA is currently located at a position “Z m” away from the crossroads CR. It is assumed that the predetermined distance from the crossroads CR is set to “Z m.” In this case, from “Z m” (a position “Z m” before the crossroads CR) to “0 m” (a position of the crossroads CR), the image processing system captures images using the imaging device and stores the captured images. The images are captured at intervals determined by a frame rate which is set in the imaging device in advance.

In Step SA03, the image processing system transmits a first image to the information processing device. Specifically, when Step SA02 is performed, a plurality of images from “0 m” to “Z m” is first acquired. Among all the images, a certain image (hereinafter referred to as a “first image”) is transmitted to the server SR by the image acquiring device IM (see FIG. 1).

The first image is, for example, an image which is captured at a position close to the crossroads CR among all the images. Specifically, it is assumed that a position corresponding to “Y m” is located between “0 m” (the position of the crossroads CR) and “Z m” (a position at which imaging is started). That is, in this example, it is assumed that a relationship of “0<Y<Z” is satisfied. Then, in this example, the first image is an image which is captured between “0 m” and “Y m.” It is assumed that the value of “Y” for defining the first image among all the images can be set in advance.

In Step SA04, the image processing system caches a second image. Specifically, the image processing system stores an image (hereinafter referred to as a “second image”) other than the first image among all the images on the vehicle CA side using the image acquiring device IM. In this example, the second image is an image which is captured between “Y m” and “Z m.” That is, the second image is an image acquired by imaging a range which is not included in the first image.

In Step SA05, the image processing system determines whether the second image has been requested. In this example, when the server SR performs Step SB06, the image processing system determines that the second image has been requested using the image acquiring device IM (YES in Step SA05).

Then, when the image processing system determines that the second image has been requested (YES in Step SA05), the image processing system performs Step SA06. On the other hand, when the image processing system determines that the second image has not been requested (NO in Step SA05), the image processing system ends the processing routine.

In Step SA06, the image processing system transmits the second image to the information processing device. Specifically, when the second image has been requested, the image processing system transmits the second image stored in Step SA04 to the server SR using the image acquiring device IM.

As described above, in the image processing system, the first image is first transmitted from the vehicle CA side. Then, when the second image is requested by the server SR side, the second image is transmitted from the vehicle CA side to the server SR side.

In Step SB01, the image processing system determines whether the first image has been received. In this example, when Step SA03 is performed by the image acquiring device IM, the first image is transmitted to the server SR and the first image is received by the server SR (YES in Step SB01).

Then, when the image processing system determines that the first image has been received (YES in Step SB01), the image processing system performs Step SB02. On the other hand, when the image processing system determines that the first image has not been received (NO in Step SB01), the image processing system performs Step SB01 again.

In Step SB02, the image processing system stores the first image. Hereinafter, it is assumed that the server SR stores an image in a database (hereinafter referred to as a “travel database DB1”).

In Step SB03, the image processing system determines whether the travel database DB1 has been updated. Specifically, when the server SR performs Step SB02, the first image is added to the travel database DB1. In this case, the image processing system determines that the travel database DB1 has been updated (YES in Step SB03).

Then, when the image processing system determines that the travel database DB1 has been updated (YES in Step SB03), the image processing system performs Step SB04. On the other hand, when the image processing system determines that the travel database DB1 has not been updated (NO in Step SB03), the image processing system performs Step SB03.

In Step SB04, the image processing system detects predetermined information based on the first image. The predetermined information is information which can be set in advance. The predetermined information is information including at least one of information serving as a marker (hereinafter referred to as “marker information”) that can specify the crossroads CR and information on congestion (hereinafter referred to as “congestion information”) which occurs around the vehicle CA. In the following description, it is assumed that the predetermined information is the marker information.

Specifically, examples of an object serving as a marker include a signboard, a building, a painted part, a lane, and a feature or a sign of a road which are installed in the vicinity of a crossroads. That is, a marker is a structure which is installed in the vicinity of the crossroads CR or is a figure, characters, numerals, or a combination thereof which are drawn on a road in the vicinity of the crossroads CR.

The image processing system recognizes a marker from the first image, for example, using deep learning.

The method of recognizing a marker is not limited to the deep learning. For example, the method of recognizing a marker may be embodied using a method described in Japanese Unexamined Patent Application Publication Nos. 2007-240198 (JP 2007-240198 A), 2009-186372 (JP 2009-186372 A), 2014-163814 (JP 2014-163814 A), or 2014-173956 (JP 2014-173956 A).

In the following description, it is assumed that a signboard is set to be recognized as a marker using the above-mentioned method.

In Step SB05, the image processing system determines whether there is a marker. Specifically, when a signboard serving as a marker is present in the vicinity of the crossroads CR, that is, when a signboard is installed in a range (a range from “0 m” to Y m″) in which the first image is captured, the signboard is photographed into the first image. In this case, the signboard is detected in Step SB04, and the image processing system determines that there is a marker (YES in Step SB05). On the other hand, when a signboard is not present in the vicinity of the crossroads CR, no signboard is photographed into the first image. Accordingly, the image processing system determines that there is no marker (NO in Step SB05).

Then, when the image processing system determines that there is a marker (YES in Step SB05), the image processing system performs Step SB12. On the other hand, when the image processing system determines there is no marker (NO in Step SB05), the image processing system performs Step SB06.

In Step SB06, the image processing system requests a second image. That is, the image processing system requests the second image which is acquired by imaging a range from “Y m” to Z m.”

In Step SB07, the image processing system determines whether the second image has been received. In this example, when the image acquiring device IM performs Step SA06, the second image is transmitted to the server SR and the second image is received by the server SR (YES in Step SB07).

Then, when the image processing system determines that the second image has been received (YES in Step SB07), the image processing system performs Step SB08. On the other hand, when the image processing system determines that the second image has not been received (NO in Step SB07), the image processing system performs Step SB07.

In Step SB08, the image processing system stores the second image. For example, the received second image is stored in the travel database DB1 similarly to the first image.

In Step SB09, the image processing system determines whether the travel database DB1 has been updated. Specifically, when the server SR performs Step SB08, the second image is added to the travel database DB1. In this case, the image processing system determines that the travel database DB1 has been updated (YES in Step SB09).

Then, when the image processing system determines that the travel database DB1 has been updated (YES in Step SB09), the image processing system performs Step SB10. On the other hand, when the image processing system determines that the travel database DB1 has not been updated (NO in Step SB09), the image processing system performs Step SB09 again.

In Step SB10, the image processing system detects predetermined information based on the second image. For example, the image processing system detects the predetermined information using the same method as in Step SB04. In Step SB10, the image processing system may detect the predetermined information using only the second image or may detect the predetermined information using both the first image and the second image.

In Step SB11, the image processing system determines whether there is a marker. First, when a signboard is installed in a range (a range from “Y m” to “Z m”) in which the second image is captured, the signboard appears in the second image. In this case, the signboard is detected in Step SB10, and the image processing system determines that there is a marker (YES in Step SB11). On the other hand, when a signboard is not present in the range in which the second image is captured, a signboard is not photographed into the second image. Accordingly, the image processing system determines that there is no marker (NO in Step SB11).

Then, when the image processing system determines that there is a marker (YES in Step SB11), the image processing system performs Step SB13. On the other hand, when the image processing system determines that there is no marker (NO in Step SB11), the image processing system ends the processing routine.

In Step SB12 and Step SB13, the image processing system stores marker information. Hereinafter, it is assumed that the server SR stores the marker information in a database (hereinafter referred to as a “guidance database DB2”).

When Step SB12 or Step SB13 is performed, it means that a signboard is present in the vicinity of the crossroads CR which is a guidance target. Therefore, in Step SB12 and Step SB13, the image processing system stores marker information indicating the position of the detected signboard or the like in the guidance database DB2. When the marker information is stored in the guidance database DB2, the car navigation device or the like can perform guidance using the marker with reference to the marker information.

<Example of Advantages>

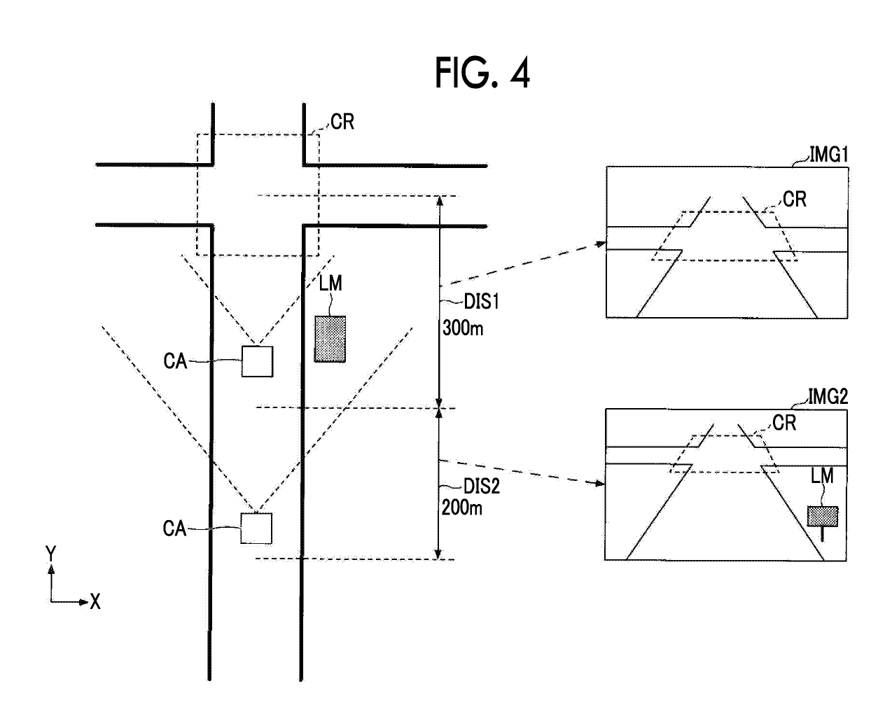

FIG. 4 is a (first) diagram illustrating an example of advantages of the first overall processing routine according to the embodiment of the disclosure. When the first overall processing routine illustrated in FIGS. 3A and 3B is performed, for example, advantages illustrated in the drawing are achieved.

First, a range within “300 m” from the crossroads CR is defined as a first distance DIS1 (a range from “0 m” to “Y m” in the above description). At the first distance DIS1, a first image IMG1 is captured and, for example, an image illustrated in the drawing is generated. As illustrated in the drawing, a signboard LM is not included in an angle of view at which the first image IMG1 is captured. Accordingly, the signboard LM as a marker is not photographed into the first image IMG1 (NO in Step SB05). Accordingly, predetermined information is not detected from the first image IMG1.

A range within “200 m” from a position separated “300 m” from the crossroads CR is defined as a second distance DIS2 (a range from “Y m” to “Z m” in the above description). As illustrated in the drawing, it is assumed that the signboard LM is installed in a range corresponding to the second distance DIS2, that is, before the crossroads CR. Accordingly, as illustrated in the drawing, the signboard LM as a marker is photographed into a second image IMG2 (YES in Step SB11). Accordingly, predetermined information is detected from the second image IMG2.

The advantages based on the first overall processing routine are achieved in the following situation.

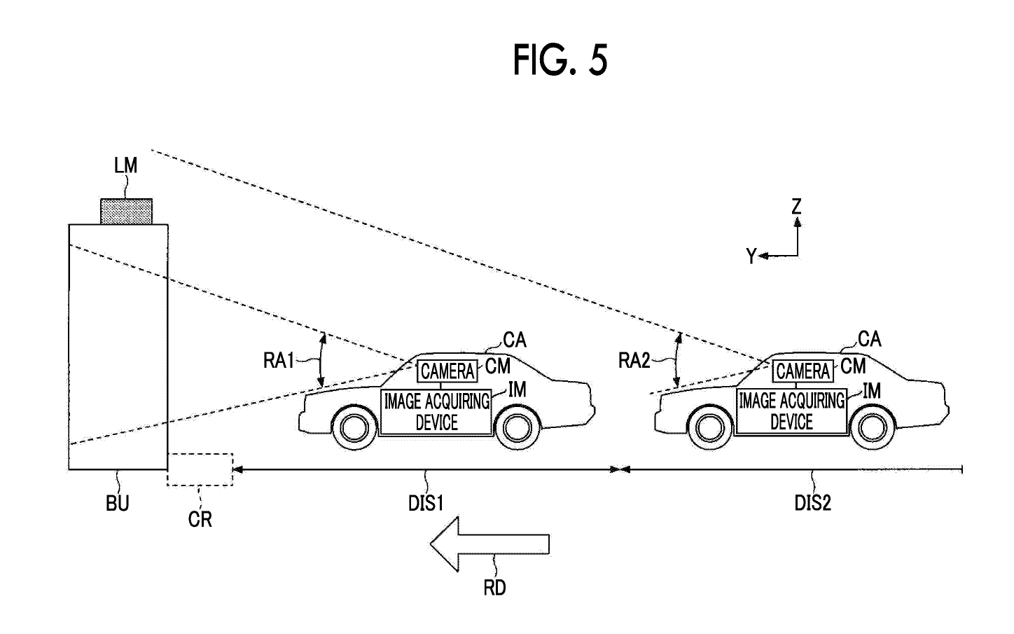

FIG. 5 is a (second) diagram illustrating an example of the advantages of the first overall processing routine according to the embodiment of the disclosure. FIG. 5 illustrates a situation in the vicinity of the crossroads CR illustrated in FIG. 4. FIG. 5 is a view (a so-called side view) other than the view of FIG. 4.

FIG. 5 is different from FIG. 4 in the position at which the signboard LM is installed. Specifically, as illustrated in the drawing, the signboard LM is installed in the vicinity of the crossroads CR in FIG. 5. It is assumed that the signboard LM is installed on a building BU in the vicinity of the crossroads CR. In this situation, for example, the following phenomenon may occur.

As illustrated in the drawing, within the first distance DIS1, the signboard LM is not included in a range (hereinafter referred to as a “first imaging range RA1”) which is imaged by the camera CM, that is, in a range indicated by the first image IMG1 (see FIG. 4), similarly to FIG. 4.

On the other hand, within the second distance DIS2 separated farther than the first distance DIS1 from the building BU, the signboard LM is included in a range (hereinafter referred to as a “second imaging range RA2”) which is imaged by the camera CM, that is, in the second image IMG2 (see FIG. 4).

Accordingly, similarly to FIG. 4, the predetermined information which cannot be detected from the first image IMG1 can be detected using the second image IMG2. In this way, a signboard LM may not be detected from the first image IMG1 due to a height (a position in a Z direction) at which the signboard LM is installed. In this case, the image processing system can detect predetermined information using the second image IMG2.

As described above, first, the image processing system is going to detect predetermined information from the first image IMG1. Then, when the image processing system can detect predetermined information from the first image IMG1, the server SR does not request the second image. Accordingly, an amount of images which are transmitted and received between the vehicle CA and the server SR decreases.

When marker information from the first image IMG1 or the second image IMG2 can be stored in the guidance database DB2, the following process can be performed.

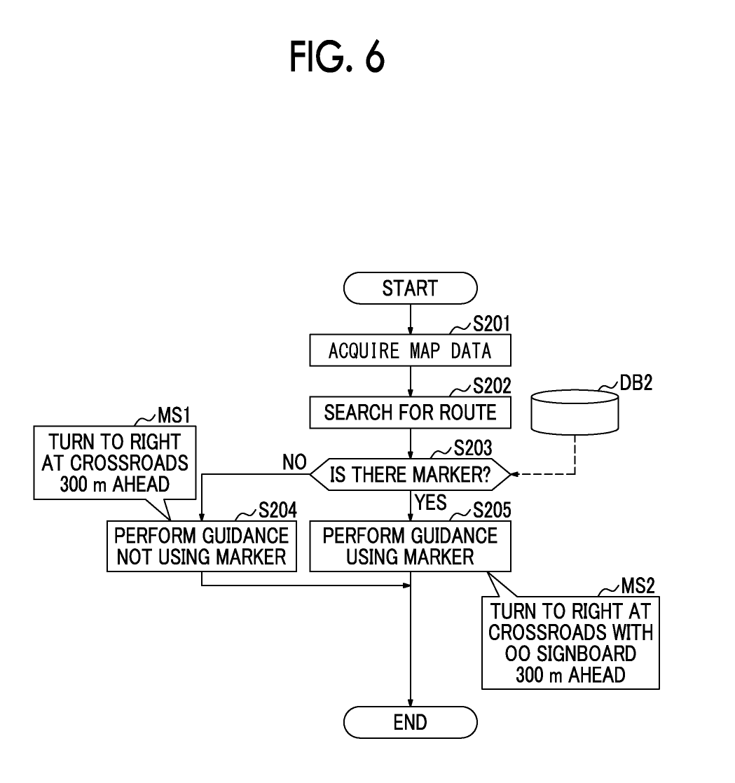

FIG. 6 is a flowchart illustrating an example of a processing routine of performing acquisition of map data and guidance in the image processing system according to the embodiment of the disclosure. For example, when there is a vehicle CA with a car navigation device or the like, it is preferable that the image processing system perform the following process.

In Step S201, the image processing system acquires map data.

In Step S202, the image processing system searches for a route.

For example, as illustrated in FIG. 2, when map data DM indicating a current position of the vehicle CA, a destination, and intermediate routes from the current position to the destination or surroundings thereof is acquired in Step S201, the image processing system can search for a route from the current position to the destination in Step S202 and can perform guidance. As illustrated in FIG. 2, when guidance for turn to the right should be performed in the route, the image processing system performs Step S203.

In Step S203, the image processing system determines whether there is a marker. Specifically, since the first overall processing routine is performed in advance, marker information is stored in the guidance database DB2 in advance when there is a marker. That is, in the first overall processing routine, when Step SB12 or Step SB13 is performed, the image processing system determines that there is a marker in Step S203 (YES in Step S203).

Then, when the image processing system determines that there is a marker (YES In Step S203), the image processing system performs Step S205. On the other hand, when the image processing system determines that there is no marker (NO in Step S203), the image processing system performs Step S204.

In Step S204, the image processing system performs guidance without using a marker. For example, as illustrated in the drawing, the image processing system outputs a message (hereinafter referred to as a “first message MS1”) including contents such as “TURN TO RIGHT AT CROSSROADS 300 m AHEAD” for a driver by a voice or image display.

In Step S205, the image processing system performs guidance using a marker. For example, as illustrated in the drawing, the image processing system outputs a message (hereinafter referred to as a “second message MS2”) including contents such as “TURN TO RIGHT AT CROSSROADS with OO SIGNBOARD 300 m AHEAD” for a driver by a voice or image display.

Step S204 is different from Step S205 in a message to be output. The first message MS1 and the second message MS2 are messages for guidance for the same crossroads, but are different from each other in whether marker information of “OO signboard” is used. Here, it is assumed that “OO signboard” is a message indicating the signboard LM in FIG. 4.

Since the marker information is stored in the guidance database DB2 in advance, the image processing system can perform guidance such that the vehicle turns to the right at the crossroads CR with the signboard LM in Step S205 as illustrated in FIG. 4. Particularly, in the situation illustrated in FIG. 2, positions at which a vehicle can turn to the right are densely present. In such a situation, when the signboard LM is used as a marker as in the second message MS2, the image processing system can surely guide a driver to a position at which the vehicle turns to the right. Accordingly, the image processing system can perform guidance for the crossroads CR more understandably in comparison with guidance not using a marker.

<Example of Second Overall Processing Routine>

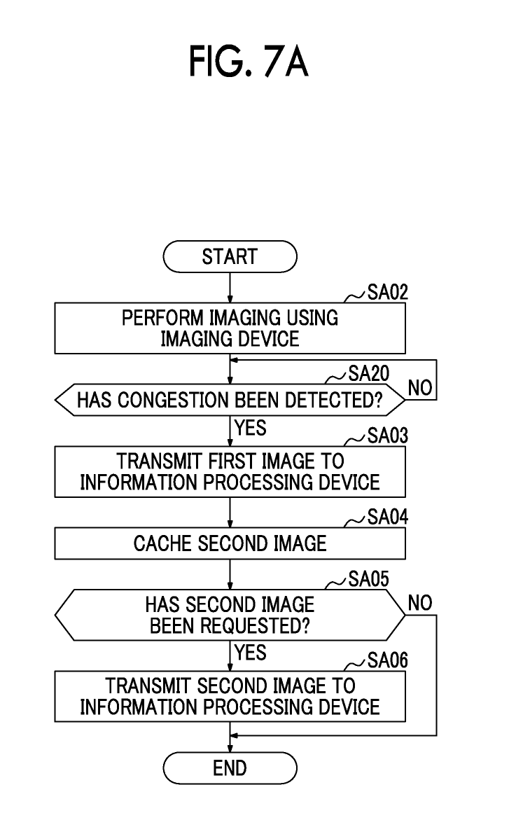

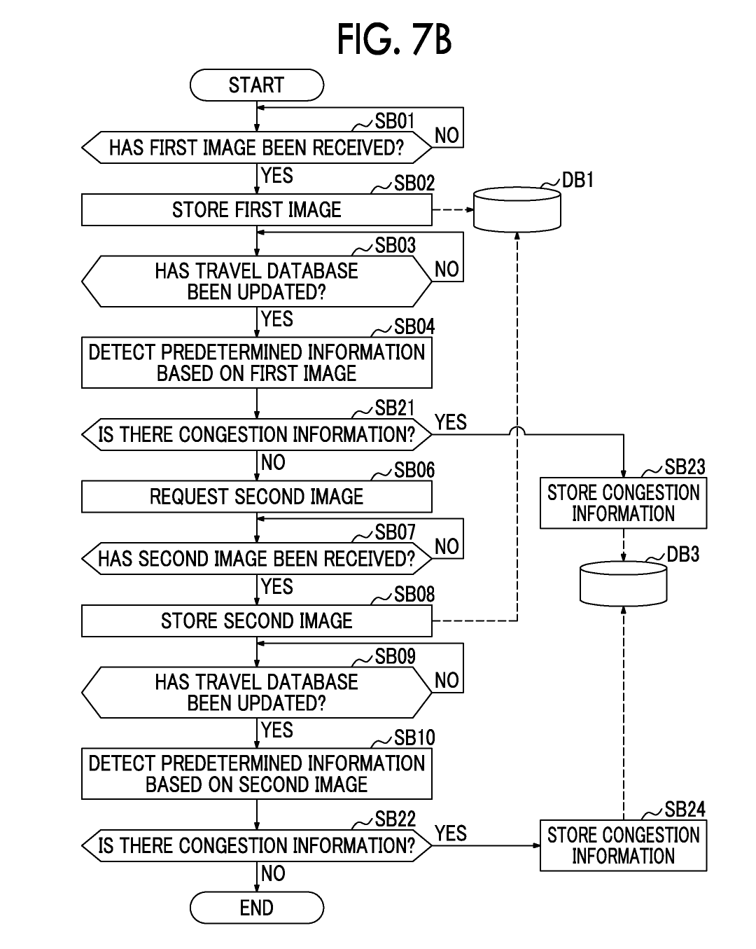

FIGS. 7A and 7B are flowcharts illustrating an example of a second overall processing routine which is performed by the image processing system according to the embodiment of the disclosure. The image processing system may perform the second overall processing routine which is described below.

The second overall processing routine is different from the first overall processing routine (see FIGS. 3A and 3B), in that predetermined information associated with congestion information is detected. Specifically, the second overall processing routine is different from the first overall processing routine, in that Steps SA01, SB05, and SB11 to SB13 are replaced with Steps SA20 and SB21 to SB24. The second overall processing routine is different from the first overall processing routine in details of Steps SB04 and SB10. The same processes as in the first overall processing routine will be referenced by the same reference signs to omit description thereof and differences will be mainly described below.

In Step SA20, the image processing system determines whether congestion has been detected. For example, when a vehicle speed becomes equal to or lower than a predetermined speed, the image processing system determines that congestion has been detected (YES in Step SA20). Whether congestion has been detected may be determined, for example, based on an inter-vehicle distance, a density of neighboring vehicles, or a time or a distance in which the vehicle speed is a low speed.

Then, when the image processing system determines that congestion has been detected (YES in Step SA20), the image processing system performs Step SA03. On the other hand, when the image processing system determines that congestion has not been detected (NO in Step SA20), the image processing system performs Step SA20.

In Step SB04, the image processing system detects predetermined information based on a first image. In the second overall processing routine, the predetermined information is information including congestion information. In the following description, it is assumed that the predetermined information is congestion information. The image processing system detects the predetermined information from the first image by deep learning or the like, similarly to the first overall processing routine.

The congestion information is information indicating, for example, a position at which the vehicle CA joins congestion, a cause of congestion, or a length of congestion. What the congestion information includes may be set in advance. Hereinafter, it is assumed that congestion information includes a traffic accident as the cause of congestion.

Specifically, when a preceding vehicle appears close in an image or a vehicle having an accident, a signboard indicating under construction, or the like appears in the image, the image processing system detects a cause of congestion by deep learning or the like. When a position at which the cause of congestion can be confirmed is known, the image processing system can understand a position at which the vehicle joins the congestion.

For example, when a position at which the vehicle joins the congestion and a position at which the congestion is released can be known, a distance between the positions is a length of congestion and thus the image processing system can detect the length of congestion.

In Step SB21, the image processing system determines whether there is congestion information. That is, when the cause of congestion is detected in Step SB04, the image processing system determines that there is congestion information (YES in Step SB21).

Then, when the image processing system determines that there is congestion information (YES in Step SB21), the image processing system performs Step SB23. On the other hand, when the image processing system determines that there is no congestion information (NO in Step SB21), the image processing system performs Step SB06.

In Step SB10, the image processing system detects predetermined information based on the second image. For example, the image processing system detects the predetermined information using the same method as in Step SB04.

In Step SB22, the image processing system determines whether there is congestion information. That is, when the cause of congestion is detected in Step SB10, the image processing system determines that there is congestion information (YES in Step SB22).

Then, when the image processing system determines that there is congestion information (YES in Step SB22), the image processing system performs Step SB24. On the other hand, when the image processing system determines that there is no congestion information (NO in Step SB22), the image processing system ends the processing routine.

In Step SB23 and Step SB24, the image processing system stores the congestion information. Hereinafter, it is assumed that the server SR stores the congestion information in a database (hereinafter referred to as a “congestion database DB3”).

When Step SB23 or Step SB24 is performed, the congestion information has been detected. Therefore, in Step SB23 and Step SB24, the image processing system stores the congestion information indicating the cause of congestion in the congestion database DB3. When the congestion information is stored in the congestion database DB3, the car navigation device or the like can inform a driver that congestion occurs with reference to the congestion information.

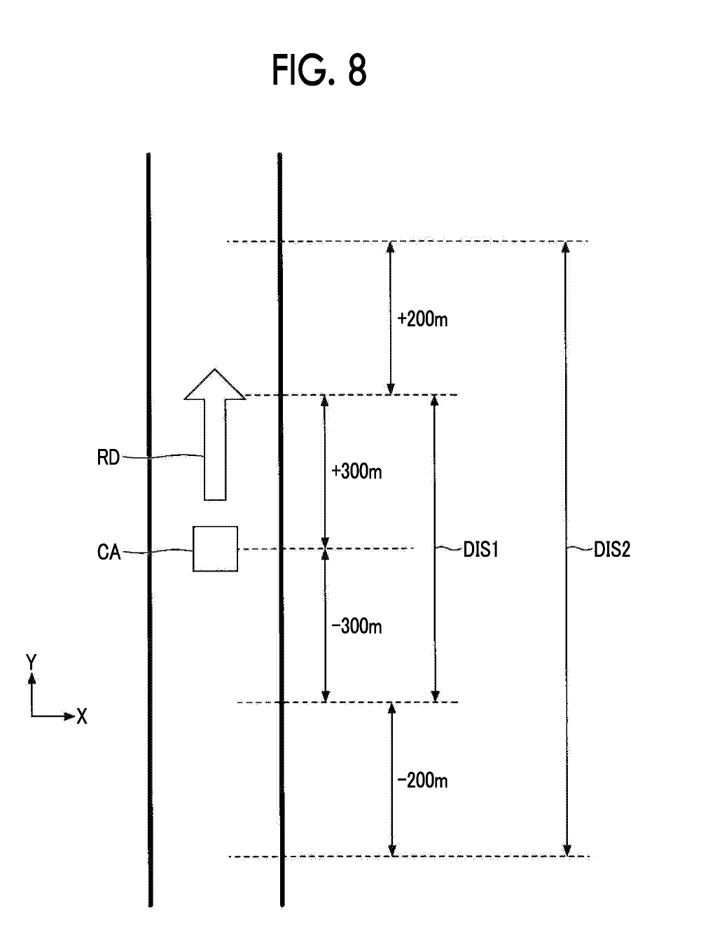

FIG. 8 is a diagram illustrating an example of advantages of the second overall processing routine according to the embodiment of the disclosure. Hereinafter, it is assumed that congestion has been detected (YES in Step SA20) at the position illustrated in the drawing. In the drawing, a direction in which the vehicle CA travels (hereinafter referred to as a “traveling direction RD”) is defined as a forward direction and is denoted by “+.”

In the second overall processing routine, for example, as illustrated in the drawing, a range within a predetermined distance before and after the position at which congestion has been detected is defined as the first distance DIS1. Specifically, in the example illustrated in the drawing, regarding the first distance DIS 1, “300 m” before and after the position at which congestion has been detected is the first distance DIS1. Accordingly, the first image is an image indicating “300 m” before and after the position at which the congestion has been detected, that is, “600 m” in total.

On the other hand, when congestion information is not detected from the first image (NO in Step SB21), the image processing system requests a second image including an area within a predetermined distance before and after greater than the first distance (Step SB06). In the illustrated example, the second distance DIS2 is a distance obtained by adding “200 m” to the first distance DIS1. Accordingly, the second image is an image indicating an area “200 m” before and after more than the first distance DIS1, “400 m” in total.

As described above, first, the image processing system is going to detect predetermined information from the first image. When the predetermined information is detected from the first image, the server SR does not request the second image. Accordingly, an amount of images which are transmitted and received between the vehicle CA and the server SR decreases.

<Example of Functional Configuration>

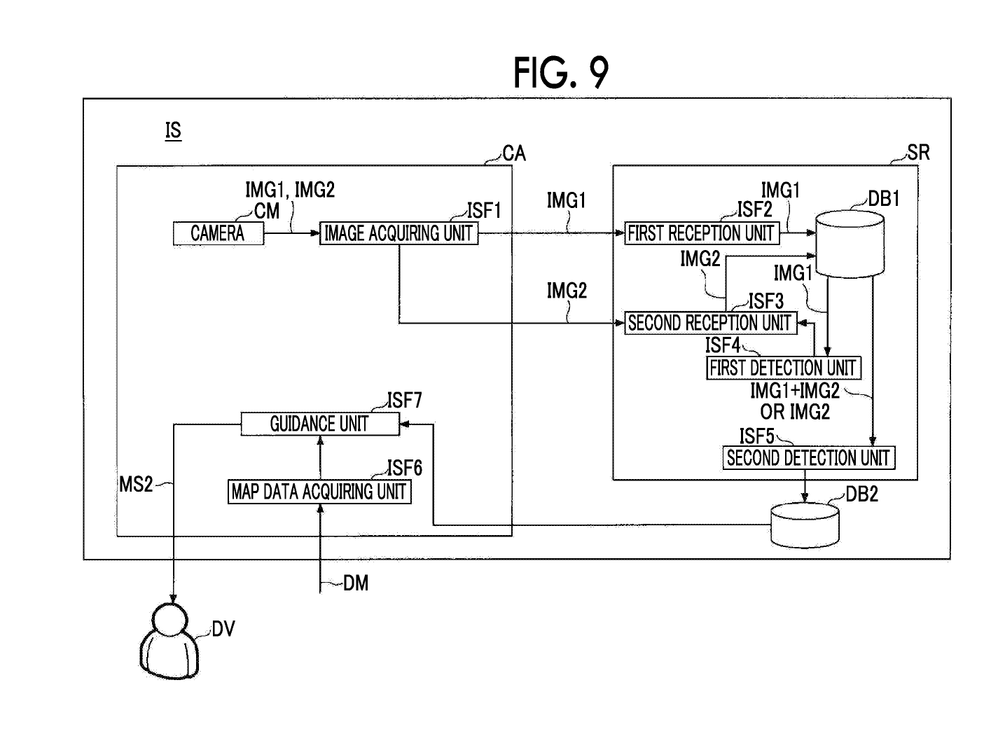

FIG. 9 is a functional block diagram illustrating an example of a functional configuration of the image processing system according to the embodiment of the disclosure. For example, the image processing system IS includes an image acquiring unit ISF1, a first reception unit ISF2, a second reception unit ISF3, a first detection unit ISF4, and a second detection unit ISF5. As illustrated in the drawing, the image processing system IS may have a functional configuration further including a map data acquiring unit ISF6 and a guidance unit ISF7.

The image acquiring unit ISF1 performs an image acquiring process of acquiring a plurality of images indicating surroundings of the vehicle CA which are captured by the camera CM. For example, the image acquiring unit ISF1 is embodied by the image acquiring device IM (see FIG. 1) or the like.

The first reception unit ISF2 performs a first reception process of receiving a first image IMG1 of the plurality of images from the image acquiring unit ISF1. For example, the first reception unit ISF2 is embodied by the communication device SH5 (see FIG. 1) or the like.

The first detection unit ISF4 performs a first detection process of detecting predetermined information including at least one of marker information of a marker indicating a crossroads and congestion information on congestion occurring around the vehicle CA based on the first image IMG1 received by the first reception unit ISF2. For example, the first detection unit ISF4 is embodied by the CPU SH1 (see FIG. 1) or the like.

When the predetermined information has not been detected by the first detection unit ISF4, the second reception unit ISF3 performs a second reception process of receiving a second image IMG2 of the plurality of images from the image acquiring unit ISF1. For example, the second reception unit ISF3 is embodied by the communication device SH5 (see FIG. 1) or the like.

The second detection unit ISF5 performs a second detection process of detecting the predetermined information based on both the first image IMG1 and the second image IMG2 or based on the second image IMG2. For example, the second detection unit ISF5 is embodied by the CPU SH1 (see FIG. 1) or the like.

The map data acquiring unit ISF6 performs a map data acquiring process of acquiring map data DM indicating a current position of the vehicle CA, a destination, and intermediate routes from the current position to the destination. For example, the map data acquiring unit ISF6 is embodied by the car navigation device or the like mounted in the vehicle.

The guidance unit ISF7 performs a guidance process of performing guidance for a route in which the vehicle CA travels based on the map data DM acquired by the map data acquiring unit ISF6. For example, the guidance unit ISF7 is embodied by the car navigation device or the like mounted in the vehicle.

First, a plurality of images including the first image IMG1 and the second image IMG2 are captured by the camera CM which is an example of the imaging device. Then, the images such as the first image IMG1 and the second image IMG2 captured by the camera CM are acquired by the image acquiring unit ISF1.

Then, the image processing system IS first causes the server SR to receive the first image IMG1 using the first reception unit ISF2. Then, the image processing system IS detects the predetermined information from the first image IMG1 using the first detection unit ISF4. For example, the first detection unit ISF4 detects the predetermined information in Step SB04 or the like.

When a subject serving as a marker such as a signboard LM (see FIG. 4) is photographed into the first image IMG1, the first detection unit ISF4 detects marker information and stores the detected marker information (Step SB12). In this way, first, the image processing system IS detects the predetermined information based on the first image IMG1 which is partial images instead of all the images (Step SB04).

When the predetermined information has not been detected by the first detection unit ISF4, that is, the predetermined information has not been detected from the first image IMG1, the image processing system IS requests the second image IMG2 using the second reception unit ISF3 (Step SB06) and additionally receives an image. The image processing system IS detects the predetermined information based on the second image IMG2 (Step SB10).

According to the above-mentioned configuration, when the predetermined information has not been detected from only the first image IMG1, the second image IMG2 is requested. Accordingly, when the second image IMG2 is not requested, an amount of data decreases by the second image IMG2. Accordingly, the image processing system IS can reduce an amount of data which is transmitted between the vehicle CA and the server SR. In this way, the image processing system IS can reduce a burden on a communication line.

On the other hand, when the predetermined information has not been detected from only the first image IMG1, the image processing system IS request the second image IMG2. According to this configuration, for example, as illustrated in FIG. 4, it is possible to detect the predetermined information. The image processing system IS can efficiently collect images from which the predetermined information can be detected. Accordingly, the image processing system IS can accurately detect the predetermined information. In this way, the image processing system IS can make accuracy of the predetermined information and a decrease in the amount of data to coexist.

Where the predetermined information is located is not often known. Accordingly, for example, in a case in which an image acquired by imaging a range within “300 m” from a crossroads is used and a case in which an image acquired by imaging a range within “500 m” from the crossroads is used, the image processing system IS can more easily detect the predetermined information in the case in which an image acquired by imaging a range within “500 m” is used. However, in the case in which an image acquired by imaging a range within “500 m” is used, an amount of data is often larger. Accordingly, in the case in which an image acquired by imaging a range within “500 m” is used, communication fees are often higher or a load in a communication line often becomes greater.

As a result of experiment, according to the functional configuration illustrated in FIG. 9, when images corresponding to “400 m” in average are collected, the image processing system IS could detect a larger amount of predetermined information than when continuous images corresponding to “300 m” are simply collected.

According to the functional configuration illustrated in FIG. 9, when images corresponding to “400 m” in average are collected, the image processing system IS could decrease the communication fees by about 20% in comparison with a case in which continuous images corresponding to “500 m” are simply collected.

When the map data acquiring unit ISF6 and the guidance unit ISF7 are provided, the image processing system IS can perform guidance using a marker for a driver DV, for example, as in the second message MS2 illustrated in FIG. 6.

### Other Embodiments

The ranges indicated by the first image and the second image are not limited to setting based on a distance. For example, it is assumed that the imaging device can capture images of 30 frames per second. For example, the image processing system IS may have settings of using 15 frames of the 30 frames as the first image and using the other 15 frames as the second image. In this way, when images which are used for detection can be added, the image processing system IS can accurately detect the predetermined information.

The map data acquiring unit ISF6 and the guidance unit ISF7 may be provided in a vehicle other than the vehicle in which the imaging device is mounted.

The above-mentioned embodiment of the disclosure may be embodied by a program causing an information processing device or a computer of an information processing system or the like to perform the processes associated with the image processing method. The program can be recorded on a computer-readable recording medium and be distributed.

Each of the above-mentioned devices may include a plurality of devices. All or some of the processes associated with the image processing method may be performed in parallel, in a distributed manner, or redundantly.

While embodiments of the disclosure have been described above, the disclosure is not limited to the embodiments but can be modified or corrected in various forms without departing from the gist of the disclosure described in the appended claims.

What is claimed is:

1. An image processing system comprising:
an imaging device mounted in a vehicle, the vehicle including an image acquiring unit configured to acquire a plurality of images indicating surroundings of the vehicle, the plurality of images being captured by the imaging device; and
an information processing device including
a first reception unit configured to receive a first image among the plurality of images from the image acquiring unit,
a first detection unit configured to detect, based on the first image, predetermined information including at least one of marker information of a marker indicating a crossroads and congestion information on congestion occurring around a position at which the first image is captured,
a second reception unit configured to receive a second image among the plurality of images from the image acquiring unit when the predetermined information is not detected by the first detection unit, and
a second detection unit configured to detect the predetermined information based on the first image and the second image or based on the second image.

2. The image processing system according to claim 1, wherein
the marker includes at least one of a signboard, a building, a painted part, a lane, and a feature or a sign of a road which are installed in a vicinity of the crossroads.

3. The image processing system according to claim 1, wherein
the imaging device is configured to capture the plurality of images when a position of the vehicle is within a predetermined distance from the crossroads.

4. The image processing system according to claim 1, wherein
the first image is an image which is captured when the vehicle is located at a position closer to the crossroads than a position at which the second image is captured.

5. The image processing system according to claim 1, further comprising:
a map data acquiring unit configured to acquire map data indicating a current position of the vehicle, a destination, and intermediate routes from the current position to the destination; and
a guidance unit configured to perform guidance for a route in which the vehicle travels based on the map data, wherein
the guidance unit is configured to perform guidance for the crossroads using the marker based on the predetermined information.

6. The image processing system according to claim 1, wherein
the congestion information includes a position at which the vehicle joins congestion, a cause of the congestion, or a distance of the congestion.

7. An image processing method comprising:
acquiring a plurality of images indicating surroundings of a vehicle, the plurality of the images being captured by an imaging device mounted in the vehicle;
receiving a first image of the plurality of images using at least one information processing device;
detecting predetermined information in the first image using the at least one information processing device, the predetermined information including at least one of marker information of a marker indicating a crossroads and congestion information on congestion occurring around the vehicle;
receiving a second image of the plurality of images using the at least one information processing device when the predetermined information is not detected in the first image using the at least one information processing device; and
detecting the predetermined information based on the first image and the second image or based on the second image using the at least one information processing device.

8. The image processing method according to claim 7, further comprising
storing the predetermined information in a database which is accessible by an on-board device mounted in the vehicle.

9. An image processing system comprising:
at least one server configured to communicate with a vehicle, the at least one server including a storage device and a processing device, wherein
the processing device is configured to:
receive a first image among a plurality of images acquired by an imaging device mounted in the vehicle, the plurality of images indicating surroundings of the vehicle;
detect predetermined information in the first image, the predetermined information including at least one of marker information of a marker indicating a crossroads and congestion information on congestion occurring around a position at which the first image is captured;
request the vehicle to transmit a second image acquired at a position other than the position at which the first image is acquired when the predetermined information is not detected in the first image; and
receive the second image and detect the predetermined information in the second image.

10. The image processing system according to claim 9, wherein
the at least one server is configured to transmit at least one of the marker information and information on a position of congestion prepared using the congestion information to at least one of the vehicle and a vehicle other than the vehicle.
